(19) United States
(12) Patent Application Publication
(10) Pub. No.: US 2014/0278574 A1
(43) Pub. Date: Sep. 18, 2014

(54) SYSTEM AND METHOD FOR DEVELOPING A DRIVER SAFETY RATING

(71) Applicant: Ernest W. BARBER, Exton, PA (US)

(72) Inventor: Ernest W. BARBER, Exton, PA (US)

(21) Appl. No.: 14/199,033

(22) Filed: Mar. 6, 2014

Related U.S. Application Data
(60) Provisional application No. 61/783,072, filed on Mar. 14, 2013.

(51) Int. Cl. B60W 40/09

(52) U.S. Cl. CPC B60W 40/09; G06Q 40/08
USPC 705/4

(57) ABSTRACT

Driver performance is assessed using existing datasets derived from conventional highway travel, such as a datasets from wireless highway toll payment systems. Existing datasets are processed to develop a driver safety rating and/or otherwise assess driver performance to determine a level of driver performance and/or risk, and to determine suitability for insurance discounts, etc. An exemplary system and method for providing a driver risk rating representative of driver performance involves: receiving from a toll transaction system toll trip data, the toll trip data reflecting data recorded as a result of operation of an automobile associated with at least one driver; processing the toll trip data to determine toll trip metrics as a function of the toll trip data; and processing the toll trip metrics in accordance with predefined data processing logic to develop a driver risk rating for each driver as a function of the toll trip data.

### CROSS-REFERENCE TO RELATED APPLICATIONS

This application is based on, and claims priority to, U.S. Provisional Patent Application No. 61/783,072, filed Mar. 14, 2013, the entire contents of which are fully incorporated herein by reference.

### FIELD OF THE INVENTION

The present invention relates generally to rating safety and/or performance of automobile drivers, and more particularly to a system and method for developing driver safety ratings from existing datasets.

### BACKGROUND

In our current society and as well known in the automobile insurance industry, virtually all drivers and/or automobiles are insured, which is generally required by law. Generally speaking, insurance companies price automobile insurance policies based at least in part on characteristics of the automobile's driver and/or driving history

Conventional methods for determining costs of motor vehicle insurance often involve gathering relevant historical data from a personal interview with or a written application completed by the applicant for the insurance and by referencing the applicant's public motor vehicle driving record that is maintained by a governmental agency such as a Bureau of Motor Vehicles. Such data results in a classification of the applicant to a broad actuarial class for which insurance rates are assigned based upon the empirical experience of the insurer. Many factors are deemed relevant to such classification in a particular actuarial class or risk level such as age, sex, marital status, location of residence, and driving record. By way of example, a record of past accidents and/or traffic citations may generally increase a driver's premium for a given insurance policy, whereas a driver's completion of driving safety classes and/or absence of accidents may generally lower a driver's premium. Indeed, there is an insurance underwriting industry that is focused on properly pricing insurance policies as a function of various factors.

Since good driving habits and/or driver performance tends to lead to fewer automobile accidents, and thus fewer insurance claims, a lower insurance premium for a “good” driver may be warranted. The insurance industry recognizes that a driver's premium should be based at least in part on an expectation of the driver's likely insurance claims, and that a discounted premium may be warranted for a “good” driver that is likely to have fewer/smaller insurance claims. Some insurance rating systems also provide discounts and surcharges for some types of use of the vehicle equipment on the vehicle and type of driver.

Make model and style are also considered in these systems. The safety rating of vehicles, theft popularity concerns, safety performance and features, repair and replacement costs, among other considerations also factor into these rating systems to price a policy. As a general example, a new and well-equipped foreign luxury vehicle would likely cost more to insure than a decade old base model US made sedan.

Traditionally, insurers have assessed risk and determined premiums principally by grouping people into actuarial classes of verifiable characteristics such as age, marital status, vehicle make, model, year or zip code. However, these actuarial classes lack a direct relationship to how the person actually drives a vehicle, and thus does not provide an accurate assessment of any particular individual's risk. Some methods involve consideration of the individual's driving record, but such records are of limited value.

A principal problem with such conventional insurance determination systems is that much of the data gathered is unlikely to reliably predict the manner or safety of future operation of the vehicle by the driver applicant since these assumption-based systems do not directly measure actual driver behaviors and are unable to predict future driving risk.

Accordingly, alternative approaches have been developed to try to gather additional information to be used in assessing a risk profile for a driver. In one prior art approach, which is believed to be used by The Progressive Corporation of Mayfield, Ohio, a specific driver's performance is measured and evaluated through the use of a telematics device carried in the driver's automobile. The telematics device includes data logging and recording functionality, and is used to capture information relating to the driver's driving habits. The gathered information is ultimately transmitted to the individual insurance company for use in assessing the driver's risk profile and pricing an insurance policy according to the assessed risk. This methodology is also proprietary, limiting its use and data collection by other insurers.

Such telematics device are relatively expensive, particularly when the aggregate cost of delivering the devices to a large number of drivers for data capture is considered. Further, there are costs associated with IT architecture to store and process data, data transmission costs and costs to incorporate the service into existing enterprise systems. There are also costs associated distribution and/or collection of such devices, and such devices may be susceptible to damage and loss. Further, such telematics devices have somewhat limited reliability and functionality. Typical telematic devices include a simple computer and an accelerometer, and functionality includes recordation of data relating to mileage, time of day, fast acceleration and hard braking.

What is needed is a system and method for assessing driver performance that avoids these disadvantages and/or provides enhanced functionality relating to driver performance.

### SUMMARY

The present invention provides a system and method for assessing driver performance using existing datasets derived from systems already in existence. The system and method involves processing such data in accordance with the novel methods described herein to develop a driver safety rating and/or otherwise assess driver performance. Accordingly, the inventive system and method allows for identification of lower risk drivers from a larger driver pool.

In a preferred embodiment, data is extracted from highway toll trip data datasets, e.g. from data routinely generated as part of E-ZPASS (NORTHEASTERN US), SUNPASS (FL), I-PASS (IL), EXPRESSTOLL (CO), AUTOEXPRESO (PR), PIKEPASS (OK), TXTAG (TX), PEACHPASS (GA), FasTrak (CA) or other wireless toll payment systems already in existence. Accordingly, the system analyzes and leverages existing stores of data collected and stored by toll highways—for a new purpose, namely, to evaluate driver risk.

In an alternative embodiment, data is extracted from other trip data datasets. For example, such trip data datasets may be gathered from cellular telephone use, satellite data communications, ALPR (automated license plate reader) systems, infrared and optical scanning systems or embedded chips in automobiles or associated components. For example, driver trip data could be collected using a GPS system into a central database and converted to UBI metrics in a similar fashion.

An exemplary system for processing, monitoring, storing, determining and communicating operational characteristics and operator performance relating to a unit of risk, from stored trip data contained in transportation highway databases, such as turnpikes, tollways or other highway systems that use technological devices, such as RFID transponders, to capture trip data and store trip data into databases. The stored dataset/database can be processed to determine a level of performance, a level of risk, and a determination and suitability of an account or driver for insurance discount and other purposes. The derived performance, risk assessment and driver rating is completed by a non-insurance entity and offered as a service, and gives the customer a means to independently qualify their risk. Customer data can be processed and a rating assigned without using personal information of the driver, allowing a driver to remain anonymous throughout the performance, risk and rating processes. Customers can connect to a web property to receive beneficial offers and services, based on their level of performance, risk assessment and safe driver rating, such as discounted automobile insurance, discounted life or health insurance and for toll industry rewards such discounted fares, mileage rewards or other services to be determined. Further, the rating systems described herein could be used to allow for flexible risk assessment, permitting the driver to pay for the risk calculated for each trip, or to pay a surcharge only when exceed over an assigned baseline risk level. Customers may also take possession of their ratings and provide same to any insurance company for discount consideration. A customer can seek a historical risk assessment, without processing future trips. A customer or others interact with their computed data on a personal computer, a mobile device, tablet, smartphone over the Internet or by other electronic means for convenient review of performance and ratings, to learn how to improve their performance, or to seek beneficial offers from companies interested in lower-risked drivers.

The system represents a new method of use for a toll transponder, a new method of use for transportation databases, a new system for evaluating a level of risk, a new large structured dataset of driver behaviors, and a new system to accurately price insurance policies.

### BRIEF DESCRIPTION OF THE FIGURES

An understanding of the following description will be facilitated by reference to the attached drawings, in which:

FIG. 1 is a diagram showing an exemplary networked computing environment including a driver risk assessment system in accordance with an exemplary embodiment of the present invention;

FIG. 2 is a schematic showing an exemplary networked computing environment showing for illustrative purposes certain functional components of a driver risk assessment system in accordance with an exemplary embodiment of the present invention;

FIG. 3 is a flow diagram illustrating an exemplary method for developing a driver risk rating as a function of the driver's toll trip history;

FIG. 4 is a flow diagram illustrating an exemplary method for developing a driver risk rating as a function of the driver's toll trip history relative to other drivers;

FIG. 5 is a flow diagram illustrating an exemplary method for developing a driver risk rating as a function of the driver's toll trip history and external environmental factors;

FIGS. 6-10 are images of exemplary graphical user interface windows providing an exemplary driver information portal supported by a system in accordance with the present invention; and

FIG. 11 is a schematic showing an exemplary driver risk assessment system in accordance with an exemplary embodiment of the present invention.

### DETAILED DESCRIPTION

### Comparison to Prior Art Systems

A principal problem with prior art telematic-based systems, is that they are only installed and monitored for a very short period of time, such as 30 or 60 days, after which risk assumptions are made based on an evaluation of the limited data gleaned during that short period of time. There is no means to account for a driver who modifies his/her driving behavior and who appears to drive safely only during that short period of time. Moreover, drivers have the opportunity to modify their behavior during that time period, which renders an inaccurate assessment of driver risk and circumvents an insurance companies attempt to more accurately price a policy. As a result, the use of telematics is largely assumption-based, on very limited data, and thus it is relatively unlikely to yield an accurate representation of driver risk. A system in accordance with the present invention solves this problem by providing the means to process all future trips in an ongoing fashion, over a period of months or years. In essence, the system creates a perpetual means to monitor driver performance and risk in an ongoing fashion.

Another problem with respect to prior art telematics-based systems is the lack of capability to consider or process stored trip data the driver accrued prior to device installation. By design, telematic or other devices, only record vehicle performance data beyond the point of installation and lack the means to process any available driver performance data prior to installation. Thus, insurance companies can only make risk assumptions and price a policy based on captured driver data beginning at the point of installation and ending at the point of removal of the telematics device, and are unable to access and correlate or consider several years of available driver trip data. Again, drivers may readily modify their driving behavior during the short evaluation period, thereby limiting and distorting the driver's perceived risk profile. A system in accordance with the present invention solves this problem by allowing for processing of historical trip data stored in toll highway databases, which in a majority of highway database systems, stores past trip data beyond one year or longer. Some systems store data for the preceding 5-year period.

Another important deficiency of prior art systems is that they lack the ability to compare and correlate individual driver behaviors recorded on the device to the surrounding traffic, road and weather conditions. These dynamic conditions experienced by the driver, such as traffic or weather conditions on the highway, are not recorded and are not used to make behavioral comparisons of these risk elements for inclusion in a risk assessment. A system in accordance with the present invention solves this problem by offering a means to identify and consider such dynamic conditions in the processing engine. For example, a telematics-based solution doesn't recognize if the driver is traveling on a snow covered highway or if the vehicle is in congested traffic.

An additional deficiency with these prior art systems is that they were never intended to make behavior comparisons of the driver to the behavior of other drivers traveling in near proximity. Such prior art systems are unable to make behavioral comparisons and differentiation that can be used to more accurately determine driver behaviors and risk. For example, although these prior art systems can determine your travel speed at 65 MPH, they cannot determine that the congested traffic around you is traveling at 45 MPH. Further still, they cannot differentiate between appropriate hard braking/accelerating, and risky behavior involving hard braking/accelerating. A system in accordance with the present invention can address this deficiency in multiple ways: by correlating voluminous data of other driver trips on the same highway and from close timeframes, and by incorporating Intelligent Transportation System feeds and traffic sensor data or by incorporating other intelligent systems capable of integrating data layers that can provide information for highway, speed, congestion or other conditions.

An obvious deficiency of telematics-based systems is that they are specifically-designed to be installed in individual vehicles and assess risk based on captured data one vehicle at a time. To address this deficiency, a system in accordance with the present invention uses previously-captured trip data contained in toll highway databases for multiple drivers, and provides a method for processing an entire multi-driver database for performance data and to make risk assessments on the entire dataset. For example, if a toll highway system has 1.62 million accounts that use technology transponders to collect trip data, then the system would process and assign a performance and risk rating for those accounts. Notably, the risk rating can be assigned as a function of a single account only, or as a function of the behavior data associated with the account in comparison to the behavior data associated with others of the 1.62 million accounts.

The insurance industry recognizes the benefit of capturing and analyzing datasets that contain driver behavior data for the purposes of assessing driver risk. Compiling these datasets through the use of telematics raises several data-related deficiencies in the datasets. For example, a particular insurance company may use telematics and incur the associated expenses and discover find that a certain percentage of drivers demonstrate higher risked behaviors and thus are not candidates for a particular discount or for a particular insurance policy. As an illustration, if 10,000 telematics devices are deployed and the data captured and analyzed reveals 3000 of those drivers to be higher risk, then the company has expended 30% of the overall acquisition cost on these drivers unnecessarily. The present system eliminates this expense by processing existing data already captured and can exclude that same 30% from the entire population by ranking the entire dataset based on performance. Further, there are currently several different companies in the industry companies that are compiling internal datasets by collecting individual customer data points into a database maintained separately from each other. Lastly, since the data is collected one driver at a time, the data is likely to be very slow to accumulate. For example, it has taken the Progressive insurance company nearly a decade to accumulate 1 million accounts using a simple device capable of collecting basic driver data. By contrast, larger toll systems collect trip data on over 1 million accounts annually, or ten times as fast. The proposed system provides means to overcome these deficiencies by leveraging stored trip data of multiple toll systems across the United States into a single significant dataset of driver behaviors to leverage the predictive power of such a dataset. For perspective, it is believed that the toll industry collects trip data on over 30 million electronic accounts that accumulate hundreds of millions of driver-miles annually that can be analyzed for driver behaviors, predictive analytics and risk assessment.

Moreover, means are provided to rate and rank the entire dataset based on driver behaviors and risk, which in the example provided, would result in 1.62 million rated and ranked unit of risk accounts.

Another problem in many prior art telematics-based systems is that they experience data capture failures as a result of cellular-network communication interruptions and hardware failures that lead to less-accurate risk assessment and subsequent policy pricing. A system in accordance with present invention reduces or eliminates such data loss concerns by leveraging the existing robust toll industry infrastructure with a demonstrated data capture success rate believed to be approximately 99%.

There also is the matter of privacy. In many prior art telematics-based systems, each customer has to agree to have a telematics device attached to his/her vehicle's data port and must therefore accept a certain level of intrusiveness. Drivers who utilize a telematics device and are subsequently determined to be a higher risk driver, have identified and potentially prejudiced themselves to an insurance company as such. A system in accordance with the present invention protects driver privacy by making participation anonymous, and the driver rating services offered by the system are independent of any insurance company.

### Overview

The present invention provides a system and method for assessing driver behavior and provides a driver risk rating that avoids the need to manufacture, distribute and collect data from telematics devices, and that provides enhanced functionality relating to driver behavior assessment. More specifically, the system and method of the present invention involve leveraging existing hardware and systems already in place for gathering data for the collection of toll payments on toll highways, and leveraging that data for an entirely different purpose—namely, evaluation of driver behaviors for insurance risk assessment and/or insurance policy underwriting and discounts. Generally speaking, the inventive system and method gather data already routinely collected and stored in connection with toll collection activities, and process such data in a novel fashion for the purpose of assessing driver performance and developing and assigning a driver risk rating.

By way of elaboration, toll highways use various technologies and systems to trigger, capture and store vehicle trip data of millions of drivers each day. The captured data generally includes, but is not limited to, date, day, time, entry location, exit location, weight, axles, lane or other data deemed pertinent by the collecting authority.

Various toll highway systems use various technologies for capturing such data. By way of example, the systems may use video and camera technologies. One popular technology uses different variants of RFID technology, mainly different frequency and protocols. The RFID devices are generally antennae attachable to the vehicle body, most often upon a windshield, that emits a unique transponder number at a specific frequency that be read by a reader/receiver used to capture the signal at tolling points. An exemplary configuration uses a battery-operated radio frequency identification (RFID) unit that transmits radio signals at a specific MHz band. The transponder contains a microprocessor and stores readable account information, such as an account number or other means to associate each transponder to the associated account. The transponder works by listening for a signal broadcast by the reader stationed at or near the toll point, such as a conventional toll booth. Antennas, or electronic readers, are positioned at each toll point. These antennas emit radio frequencies that communicate with the transponder. These two devices, the transponder and the antenna, interact to complete the toll transaction. A lane controller is the computer that controls the lane equipment and tracks vehicles passing through and is connected to the local network at the toll location, such as at an interchange. The lane controller transmits the data to the local network as cars traverse through the tolling points. That data is then transmitted over a network to the Host computer system and central database. Some electronic toll-collection systems may also include a light curtain and treadles. A light curtain is a beam of light that is directed across the lane. When that beam of light is broken, the system knows a car has entered. Treadles are sensor strips embedded in the toll lane that detects the number of axles a vehicle and weight. The technologies that trigger the data capture at highway entry/exit points are primarily RFID transponders. Various toll highway systems primarily use different variants of RFID technology, mainly different frequency and protocols, though video/camera-based technologies are sometimes used. Examples, of such RFID-based toll payment systems include the EZ-PASS system currently used by 22 million customers in 14 states in the northeastern US, and SUNPASS system in use in Florida.

The system includes a networked computing environment that captures data when a vehicle enters a toll system and passes through the ‘reader.’ The same trigger event occurs when the vehicle exits the toll highway. The captured data is stored in the database and is used to periodically calculate road usage fees based on that authority's charging formula and rate schedule. The raw trip data is later reconciled to form a complete trip then posted to the customer account. Since each toll transponder is unique, the data collected is associated with a specific user account. As an alternative tolling method, some systems use open road tolling which periodically triggers a data capture at intervals along the highway rather than at entry and exit points. Regardless of the configuration deployed by the highway system, each time a vehicle triggers an event at a toll point, data is captured by a machine and electronically transmitted to a central database over a network. The data is eventually reconciled and stored, often for several years, in the highway system's database.

The data stored in the highway systems' databases represent a large structured dataset capable of rendering information for assessment of driver behaviors for the insurance industry in accordance with the present invention.

An exemplary system in accordance with the present invention is a networked computing system operatively connected to the toll system's database to acquire the data needed to for processing in accordance with the methods described herein. By way of example, the systems may be interconnected via a Virtual Private Network (VPN). The data gathered may include time/date stamps, day, location information, transponder number, account number, weight, number of axles and other data for entry and exit points. Not all collected data by the toll system may be pertinent in the context of the inventive system described herein, and thus a subset of the toll data may be retrieved, or extraneous data may be retrieved but discarded. In one embodiment, all trip data for each individual account is acquired, but no personal data is acquired. As described in further detail below, the system may be configured to protect driver privacy until the driver affirmatively chooses to identify himself/herself to an insurance company.

Accordingly, during routine operation for toll-collection purposes, these transportation highway systems add data to transportation highway databases. These databases represent ever-increasing voluminous data silos, some of which, add over one million trip transactions per day to their volume. Traditionally, these databases have been used exclusively for road charging purposes to determine the fare due when a customer uses a particular section of highway.

The database spans years of driver activity and represents a large, continuous and perpetual dataset of stored driver trips for every trip traveled by every vehicle. Since toll trips are collected each and every time a vehicle's transponder triggers an event, the data stored provides a perpetual means to make driver behavior and risk assessments. In accordance with the present invention, the database can be used to calculate performance for the individual driver and for the overall population under the various conditions encountered. Meaningful comparisons against an entire population and against the pertinent traffic population on the same section of highway during the same timeframe can be made creating context, that allows individual driver performance to be compared and contrasted to all users of that particular highway. The result is a high degree of accuracy with regard to driver performance, unit-of-risk association and predictive driver analytics that directly connect driving behaviors to insurance policy risk pricing.

In accordance with the present invention, it has been determined that by applying new driver analytics to these very large data sets, new possibilities for drivers to be differentiated from each other with regard to performance, risk evaluation and subsequent determination that a driver is a lower risked driver is possible. The performance metrics used to differentiate drivers in this data environment include raw data elements, derived data elements computed using the raw data elements, traffic sensor locations, data and streams, highway conditions, weather sensor data locations and streams and conditions, and comparative and predictive analysis. The dynamic conditions that can be analyzed include, but are not limited to, speed, congestion, time, day, mileage, weather and highway conditions, all of which render insights as to driver performance and risk. For example, external conditions and factors entirely separate from, and not captured by, toll data can be assessed, integrated and interpreted based on actual driver usage, such as deer collision risk. For example, a data layer of deer rut patterns and seasons can be used to further assess risk for drivers in those areas based on entry and exit points, mileage and time/date stamp data.

The accounts are then processed via the inventive system's risk assessment engine to assess various elements of driver risk. Such assessment involves processing gathered data in accordance with methodologies described herein. The engine then determines a driver rating and rank based on the computed driver performance. The derived assessment is intended to be coordinated and verified by partner insurance companies who can then assign a level of risk to the account and accurately price an insurance policy.

For perspective, it is noted that the Pennsylvania Turnpike Commission is understood to have approximately 1.62 million E-ZPass accounts and hundreds of millions of trips stored within these accounts dating back several years. Accordingly, I have recognized that such a pre-existing data store can be a valuable resource in assessing driver performance. It allows a significant number of comparisons for differentiating driver performance and assessing risk. At the core of the present system is the ability to more accurately assign driver risk based on trip behaviors. This is accomplished by comparing individual drivers to moving populations under the same conditions and timeframes. As an illustration, envision driving on a highway during rush hour and seeing an aggressive driver threading through traffic. By comparing individual performance to the population of other drivers around the aggressive driver, they can be isolated based on trip data. In essence higher risked and aggressive drivers can be identified, and potentially eliminated from a pool of insureds, if appropriate. It is understood that there are approximately 22 million E-ZPass transponder users in the northeast United States alone, and thus the commercial market is believed to be very significant with an estimated 30 million transponders in use across the us by the various brands/protocols. Transponder usage has also increased annually and is expected to continue on that trend, thereby producing an increasing volume of the available drivers and trip data that can evaluated by the proposed system. Moreover, there appears to be a developing trend to add toll collection to existing non-toll highways in an effort to fund infrastructure repairs to such highway systems.

In one embodiment, the driver/insurance consumer may be directed to a web site interface that may present them with their driver risk ratings developed by the system. The web site may further provide the insurance consumer with advertising and/or promotional offers to connect to insurance companies for offers, review their performance, participate socially or to learn how to improve their risk ratings, or reduce their risk on the specific toll highways they use. For example, the system can leverage congestion data and make a recommendation to insured customers that by avoiding traffic volumes between locations x and y between the hours of 08:30 09:00 am, the driver could reduce his/her risk profile and increase his/her discount. By way of alternative example, a trip in poor weather conditions can be evaluated and recommendations can be made to the customer through an account, such as text, email or a feedback loop of how the driver can reduce his/her risk based on how others performed during those same conditions. Both the insurer and the insurance consumer are provided with ways to improve driving behaviors in specific conditions encountered by the driver using the experience of how a baseline group performed in those conditions. By way of further example, if 1500 cars traveled through a heavy rain storm between point a and point b in a 20 minute window with an average speed of 59 mph, an individual driver logging a speed of 67 mph may be alerted by the system as to the observed difference in performance, and may be further provided with a recommendation for improving the driver's driving behavior.

In one embodiment, the driver/insurance customer, while managing their transponder account at the toll host system online, is presented with both account management functionality and behavior rating functionality. For example, it is understood that 70% of E-ZPass accounts on the PA turnpike are managed by the customer online. A driver can manage their transponder account at the toll highway database and be presented with their performance rating via a website interface.

In contrast to driver risk assessment models involving use of telematic modules, the inventive system doesn't collect individual driver behavior and trip data, but rather uses existing, independently-developed large transportation databases that already have stored trip data contained in them, and is designed to process millions of accounts instead of temporarily collecting limited trips from individual drivers. It's also independent of any insurance company. Accordingly, the present invention provides for identifying of lower-risked drivers as a consumer service offering, rather than as a discount at an insurance company.

### Discussion of Exemplary Embodiments

For illustrative purposes, exemplary embodiments of the present invention are discussed below with reference to FIGS. 1-6. FIG. 1 is a schematic diagram showing an exemplary networked computing environment 10 including a driver risk assessment computing system 200 in accordance with an exemplary embodiment of the present invention. As shown in FIG. 1, the exemplary system includes a conventional toll transaction system (TTS) 100. Accordingly, as referenced above, the TTS 100 includes hardware and/or software positioned at highway tolling points for collecting toll payments and gathering and storing toll trip data in the toll transaction system 100. For example, the TTS 100 may be of a type offered in Pennsylvania as an E-ZPASS system, that involves wireless communication with RFID transponders positioned in the vehicles 50a, 50b of individual drivers, such as Insured A and Insured B. Such systems and their workings are well-known in the art and beyond the scope of the present invention, and thus are not discussed in further detail herein.

As further illustrated by FIG. 1, in accordance with the present invention, the networked computing environment 10 further includes a driver risk assessment system (DRAS) 200. In this exemplary embodiment, the DRAS 200 is operatively connected to the toll transaction system 100 via a communications network, such as the Internet and/or a Virtual Private Network (VPN) connection. Hardware and software for enabling communication of data via communications networks are well known in the art and beyond the scope of the present invention, and thus are not discussed in detail herein. Accordingly, in this embodiment, the DRAS 200 is capable of receiving toll trip data from the TTS 100 via the communications network 40. However, in alternative embodiments, the toll trip data gathered by the TTS 100 may be communicated to the DRAS 200 by other means, e.g., by storing the toll trip data on tangible computer readable media and physically transporting such media to the DRAS 200 where it may be read so that the toll trip data may be retrieved therefrom. In another embodiment, the DRAS 200 may be integrated into the TTS 100, thereby obviating the need to communicate trip data outside the TTS.

Referring again to FIG. 1, the exemplary networked computing environment 10 further includes computing devices operated by individual drivers/insureds, such as personal computer 30a and web-enabled smartphone 30b. Any suitable computing device may be used for this purpose. As referred to briefly above and as described in further detail below with reference to FIG. 6, the DRAS may receive from individual drivers/insureds requests to display their driver risk ratings and/or provide their driver risk ratings to one or more insurance companies, e.g., via information exchanged via a web page (or any other suitable information portal) supported by the DRAS 200. Accordingly, in this embodiment, individual drivers/insureds may operate their computing devices to view such driver risk ratings/data by communicating with DRAS via the communications network 40. Hardware and software for enabling web-based (and other) communication of data to client computing devices are well known in the art and beyond the scope of the present invention, and thus are not discussed in detail herein.

Referring again to FIG. 1, the exemplary networked computing environment 10 further includes computing systems 20a, 20b, 20c of individual insurance companies that are operatively connected to the communications network 40 for communication with the DRAS 200. Hardware and software for enabling communication of data to between such computing systems are well known in the art and beyond the scope of the present invention, and thus are not discussed in detail herein. As referenced above and as described in further detail below, the DRAS may receive information from such insurance companies' systems 20a, 20b, 20c, such as information identifying risk preferences, information for use in preparing risk ratings in accordance with the insurance company's needs, promotional offers, and requests for driver risk ratings. Additionally, the DRAS may transmit information to such insurance companies' systems 20a, 20b, 20c, such as driver risk ratings developed by the DRAS.

FIG. 2 is a schematic diagram showing an alternative networked computing environment 10. For illustrative clarity, this diagram shows the TTS 100 and DRAS 200 in schematic fashion, to depict certain logical components of each system. Further, this diagram omits the insureds' computing devices 30a, 30b and automobiles 50a, 50b, and the insurance companies' systems 20a, 20b, 20c, for illustrative clarity. For discussion purposes, this diagram also shows exemplary external data sources 250 that are operatively connected to the communications network 40, such that data from such data sources may be communicated to the DRAS for the purposes described herein. By way of example, such data sources may be web pages, information feeds delivered via web services, or simply repositories of data, as will be appreciated by those skilled in the art. In a preferred embodiment, these external data sources are pre-existing, commercially-available data sources. These data sources are referred to herein as “external” in that they are independent of and maintained separately from the TTS and DRAS systems.

Certain aspects of development of driver risk ratings in accordance with the present invention are discussed below with reference to FIGS. 3-6. Referring now to FIG. 3, a flow diagram 300 is shown that illustrates an exemplary method for developing a driver risk rating as a function of the driver's toll trip history. A characteristic of this exemplary method is that the driver risk rating is determined based primarily upon toll trip data from a TTS 100, and certain relatively-static data that may be pre-stored on the DRAS, or be otherwise accessible to the DRAS. As shown in FIG. 3, this exemplary method begins with receipt from a TTS 100 toll trip data relating to a driver, as shown at step 302. This step involves receipt of such toll trip data at the DRAS 200. By way of example such toll trip data may include the following information: transponder identification number, account identification number, entry point location, exit point location, entry point time and date, exit point time and date, weight, number of axles, etc. Optionally, this step may include storing such toll transaction data in a risk assessment data store 220 of the DRAS 200, as shown in FIG. 2. By way of example, the risk assessment data store 220 may store driver accounts, 230a, 230b, 230c, and each driver's toll transaction data 250a, 250b, 250c may be stored in associate with the corresponding driver account.

Notably, certain commercial carriers may choose to track their drivers' behaviors for internal purposes, since it ultimately impacts their insurance costs. A practical application would be to monitor trip performance of hazmat loads or high value loads such as pharmaceutical loads, as these types of loads often have additional insurance costs/considerations. Trip performance can be monitored on these loads to make adjustments to the risk model on future loads or to rate drivers of these loads. Thus, the system can be used by commercial carriers to build, maintain or validate their company safety ratings, which impacts their insurance costs, ability to secure loads, transportation terms, etc. For example, a company with a higher safety rating may be able to demand beneficial terms to move a particular load.

In one exemplary embodiment, such data is received directly from the TTS 100 as communicated via the communications network 40. In one preferred embodiment, such toll trip data is received from the TTS 100 after a trip reconciliation process and before permanent storage of such trip data in association with a specific driver's account. As known in the field, the ‘trip reconciliation’ process is a specific process where transponder-triggered entry and exit events are matched together and posted with the TTS as a complete trip, before the trip data is posted to an individual driver's account. Accordingly, at this point the trip data is anonymous information in that the trip data itself does not identify any specific driver in any readily-identifiable manner. Such data does however “relate” to a driver in that it includes transponder identification number information that is associated a specific driver, as known by the TTS, but in a manner that is not apparent to the DRAS. By receiving data as a feed at this point, the DRAS can acquire the data needed, before it's posted to the closed TTS system, which is believed likely to avoid certain legislative and/or customer privacy concerns.

After trip reconciliation, and in systems that function is a different manner, such trip data is stored by the TTS in association with the corresponding driver's account. As shown is FIG. 2, the TTS 100 may store such toll trip data in its toll transaction data store 120 as Driver Toll Transaction Data 150a, 150b, 150c in a corresponding driver account 130a, 130b, 130c of that may further include personal data 140a, 140b, 140c, such as the name, address, telephone number, credit card information, etc. of the driver. In alternative embodiments, the DRAS 200 may receive from the TTS 100 after storage of the toll transaction data 150a, 150b, 150c in the data store 120 apart from any associated personal data 140a, 140b, 140c, or may receive such toll transaction data from the data store 120 along with associate personal data, but may discard or otherwise safeguard such personal data.

It is preferred that in all embodiments that the DRAS tracks “driver” data and performance in a manner such that the driver is identified by toll transponder identification code or account identification code alone, and not by personal information such as name, etc.

Referring again to FIG. 3, the method next involves processing the toll trip data to determining toll trip metrics as a function of the toll trip data, as shown at step 304. Referring to FIG. 2, this step may be performed at the DRAS 200 by a software-implemented risk assessment engine 280 that is configured with data processing logic 284 stored in the memory of the DRAS. The data processing logic may include mathematical equations and/or rules for classifying, counting and/or aggregating toll trip data to determine the toll trip metrics. Optionally, this step may include storing such metrics in the risk assessment data store 220 of the DRAS 200, as shown in FIG. 2. By way of example, the risk assessment data store 220 may store driver metrics in each of the corresponding driver accounts, 230a, 230b, 230c.

In one embodiment, the system permits the driver to apply permissions to various driver metrics/data, such that the driver can expressly include or exclude certain metrics or data from use in assessing the driver's risk. For example, the system can recalculate performance/ratings based on changing the metrics specified by the individual driver. The practical application is that some drivers may not want speed used in their calculations, but feel they would qualify for a mileage, conditions or time of use discount. Such a driver can toggle off the speed metric and recalculate a discount. Accordingly, a driver may personalize their level of participation and customize their risk profile by choosing to include or omit certain metrics in their rating calculations based on their privacy preferences, known driving habits or their desire to save money on an insurance policy. Drivers may research and investigate how the different metrics affect their rating by including or omitting metrics then recalculate their rating and discount availability adjusted to reflect their metric preferences. For example, a driver may omit a mileage metric if they believe they drive beyond the insurance industry's discount threshold for that metric. In another embodiment, a driver can select to have their historical data included in their risk profile to build a long term rating from stored past trips or may choose to include future trips to invoke a perpetual rating, both of which may impact risk and savings. In another example, a safe driver may choose to use all metrics to maximize their rating and discount availability form participating insurers. Of course, reducing metrics from the processing engine may reduce the drivers rating and may reduce discount availability from an insurer.

For illustrative purposes, the table below provides examples of how the DRAS may determine toll trip metrics from the toll trip data received from the TTS 100 in conjunction with certain relatively static data that applies to all drivers, e.g., the relationships between the geographic locations of each entry point location and each exit point location, daytime hours, nighttime hours, weekend dates, etc.

| Toll Trip Metric | Toll Trip data from TTS | Static Data | Methodology |
|---|---|---|---|
| Basic Speed | Entry point location, exit | Distance between | Calculate speed as |
| | point location, entry point | entry and exit | distance per unit of time |
| | time, exit point time | points | |
| Miles Per trip | Entry point location, exit | Distance between | Calculate/retain |
| | point location | entry and exit | distance for each trip |
| | | points | |
| Mileage Total | Entry point locations, exit | Distances | Aggregate all miles for |
| | point locations | between entry and | all trips |
| | | exit points | |
| Average Mileage | Entry point locations, exit | Distances | Aggregate all miles for |
| | point locations | between entry and | all trips and divide by |
| | | exit points | the number of trips |
| Weekend Mileage | Entry point locations, exit | Distances | Aggregate all miles for |
| | point locations, entry point | between entry and | all trips that occurred on |
| | dates, exit point dates, | exit points | weekend dates |
| | weekend dates | | |

Examples of additional exemplary metrics are described briefly below:

Delta Average Mileage—a measure of a change in mileage on longer trips as longer trips may expose the driver to varying road and congestion factors outside their usual driving pattern.

Hours of Day—a tabulation of the times a driver is documented using a toll highway from time stamp data during a 24 hour time frame of a day. This metric may be tabulated by creating a simple usage table based a 24 hour clock. The time stamp of each trip may be transferred to the table and a summary for the rating period prepared to show the percentage of trips in each hour of the 24 hour clock. This metric can be used in subsequent metric calculations to identify drivers who avoid high volume traffic or conversely, who routinely drive during congested rush hours or in other metrics in which a comparison to a time of day metric would be beneficial.

Day Driving Hours—a more specific ‘hours of day’ calculation. This can be used to determine a percentage of hours spent driving in daylight. This metric may be derived by comparing the ‘hours of day’ metric to periods of light, such as from a sunrise/sunset table, and computing the time the driver spends driving in daylight.

Night Driving Hours—a more specific ‘hours of day’ calculation. Used to determine a percentage of hours spent driving during nighttime hours. This metric can be derived by comparing the ‘hours of day’ metric to periods of darkness, such as from a sunrise/sunset table, and computing the time the driver spends driving in darkness. Night time driving has a higher driver risk due to restricted vision for all drivers. For example, a driver traveling at 70 mph in the dark and relying on headlamps to see objects, such as a tire ‘gator’ in the road, recognizes the object in the road at a much closer distance at night then in daylight, which negatively affects a drivers ability to perceive and react in time.

Danger Hours—a tabulation of how many times the driver used the toll highway during times of elevated danger and risk as recognized by the insurance industry. The auto insurance industry generally regards 2400-0400 hours as hours correlated with higher driving risk. This metric can be derived by calling the table for the ‘hours of day’ metric to tabulate the percentage of trips in each hour of the 24 hour clock with a focus on the hours spent driving during times of elevated dangerous driving, namely 2400-0400. Night time driving has a higher driver risk due to restricted vision for all drivers.

Weekend Danger Hours—a tabulation of how many times the driver used the toll highway during times of elevated danger and risk, as established by the auto insurance industry; on a Friday or Saturday night, 2400-0400 hours, a time when most fatalities occur, according to the insurance industry. This metric builds upon the ‘danger hours’ described above and combines the ‘danger hours’ captured and tabulated with a Friday and Saturday ‘day’ metric which can be achieved by combining data tables or with software loops and counters. It is understood that driving during ‘danger hours’ on a Friday or Saturday night incurs additional risk most often associated with alcohol-related crashes.

Total Trips—the total number of trips. The insurance industry may establish a minimum number of Total Trips that will be required to validate safe driver performance rating and the associated risk assessment. An alternative is to assign a weight to the rating based on the number of trips a person makes per month or rating period. The more trips a driver makes, the more accurate the rating. This metric is a counter that can be used to account for trip frequency, as a trip volume barometer by the insurance industry, or in conjunction with any metric that requires a number of trips to calculate an overall average such as for speed or mileage.

Excessive Night speed—a measure of the number of times a driver's speed exceeded a threshold speed value during nighttime hours, to identify drivers who ‘outdrive’ their headlamps so that objects in the highway cannot be seen and reacted to in time. This metric can compare ‘night time hours’ to individual trip speed and tabulate the number of times in a rating period the driver engaged in excessive speeding during night time hours. ‘Excessive speeding’ could be a variable whose value could be adjusted via software or alternatively by the weighting co-efficient in an insurance companies risk profile. This metric may easily be adapted to a ‘danger hours’ related metric capable of measuring drivers from the dataset who drive at excessive speeds during ‘danger hours’ or ‘weekend danger hours’.

Animal collision driving—a measure of time that a driver spends driving on a tolled highway during times of elevated animal collision risk. For example, this could be a counter such as an accrual of hours or expressed as a percentage of total driving time during rut hours. Animal-related crashes account for significant loss rates especially during ‘rut’ season for certain animals, namely deer in October, November and December. Animal rut patterns can be overlaid with highway data and compared to usage patterns of a driver. This can be used to adjust risk, when correlated with location, mileage, hours of use and speed at night in areas of elevated ‘rut-risk’. Drivers who travel these sections of highways at night during these cycles have an increased chance of striking a deer. By way of example, this metric may be a function of “night time hours’ and/or ‘total trips’ as compared to data layers that predict geo-local rut times and possibly temperature or moon-phases. Optionally, locations of posted deer warning signs could also be overlayed. As an insurance feature, this metric could be used to identify and warn specific customers along specific highway stretches as a service (e.g., via text or email) during these elevated risk times.

It should be noted that in this exemplary method, the driver's recent driving performance may also be compared or related to the driver's historical driving performance to provide context to any particular toll trip metrics. Further, the driver risk rating determination may be configured to account for these contextual comparisons. Examples of exemplary contextual metrics based on a single driver's toll trip data (and any static data) include:

Computed Trip Speed—the average speed computed between entry and exit points computed for each trip traveled on the toll highway. This will likely vary from the posted speed limit for most drivers.

Delta Posted Speed Limit—the difference between the Computed Trip Speed and the posted speed.

Delta Posted Speed Limit Total—the number of times a vehicle traveled faster than the posted speed limit by a threshold value (e.g., 6 MPH) or more.

Average Trip Speed—the sum of the Computed Trip Speeds divided by the number of trips by week, month or year.

Delta Driver Mean Trip—when a driver travels faster than their established Average Trip Speed. For example, if their Average Trip Speed is 73 MPH, and on a particular trip they travel 83 MPH, this metric captures that behavior since the driver is out of their usual baseline. This allows for a driver to be compared to others around him, the signed speed, or his individual baseline driving speed.

Delta Driver Mean Trip Total—the sum of the number of times a driver's speed exceeded their Average Trip Speed. This can be used to calculate driver consistency by determining the percentage that the driver travels outside his baseline performance.

Individual Posted Speed baseline—a measure of how well the driver establishes and maintains a steady performance baseline trip after trip, over time, based on the posted speed of the traveled highway.

Speed Limit Adherence %—a percentage of trips in which a driver exceeded the posted speed limit.

Referring again to FIG. 3, the DRAS 200 then processes the toll trip metrics in accordance with pre-defined data processing logic to develop a driver risk rating or risk profile for the driver, as shown at 306. Referring to FIG. 2, such processing may be performed by the risk assessment engine 280. It will be appreciated that virtually any satisfactory methodology or equation may be used to determine a driver risk rating as a function of the toll trip history, and all such methodologies and equations are considered within the scope of the present invention.

Preferably, at least a portion of the logic used represents or corresponds closely to methodology used by insurance companies for assessing driver risk. Optionally, the logic may aggregate numerous risk assessment methodologies into a single number reflective of driver rating, in a manner somewhat analogous to a consumer credit score that is a single number representative of a consumer's overall credit risk profile. By way of a very simple example, this processing may involve comparing the computer basic speed to an applicable posted speed limit (which may be static data stored by the system). Further, this processing may combine risk factors in a single equation to calculate a single risk rating, and further may include weighing coefficients for each risk factor. Further still, in some embodiments each insurance company is permitted to specify weighting coefficients (or corresponding weightings) to be used in determining ratings for that specific company's use, so that they accurately reflect the company's risk underwriting process.

By way of a simple, non-limiting example, an exemplary driver risk rating may be calculated by rating the driver in a variable number of categories to arrive at a rating represented as a percentage for each category. The sum of those individual categories could then be divided by the actual number of categories to arrive a single averaged rating.

Alternatively, a driver rating can be calculated similar to a consumer credit rating. For example, percentages and weights could be assigned to various categories such as ‘speed’, mileage’, day, time, and other direct driving behaviors gleaned from metrics to arrive at a rating representative of the driver's current behavior and rating. Additional driver-related categories that might then be considered are positive driving baselines and negative baselines for the current rating period. The model could then contemplate historical trips that may be available or future trips including whether the driver chose to have perpetual trips calculated and for what period of time. These and other factors can then be used to arrive at a single calculation representing a number that can readily interpreted by insurers and drivers.

With such a model, a low risk driver can anticipate to build good driver credit and use that to secure a better policy especially when compared to and ranked in an entire dataset. For example, a top 10% driver of 1 million account dataset could leverage outstanding driver credit to get a higher discount. Of course negative performance during the discounted policy period would then negatively affect the drivers future risk credit.

Alternatively, a driver may perform in the 84th percentile in the speed metric or category. An insurer could then integrate their own risk coefficients or weights to the metric based how they want to link the drivers behavior to correspond to their company's risk model for speed. Perhaps speed as a payout/risk factor has increased for an insurer, they could assign a weight to particular category or specific metric would change their profile. Additionally, State Farm may want to assign a higher weight to a speed metric than does Allstate. The variable weight could be adjusted in their profile applied to the rating system. This method is interesting because it allows an insurance company's profile to be stored and called at the end of the process. If you want your rating sent to Allstate and State Farm for competitive bidding the appropriate company risk profile is called and used to adjust the rating into terms that the company sets.

From a marketing or business perspective, an insurance company may also choose to periodically lower their risk profile to attract more customers with slightly higher associated risks. They could achieve this by weighting various segments in their profile so as to limit or extend the volume of drivers their discount would encompass.

The method next involves storing the driver risk rating in association with the driver, as shown at step 308. For example, this step may include storing such driver risk ratings 240a, 240b, 240c in each respective driver's account 230a, 230b, 230c in the risk assessment data store 220 of the DRAS 200, as shown in FIG. 2. Again, as referred to above, the driver accounts may not identify the driver specifically, but may rather simply identify a transponder or account identification code. Accordingly, each driver account is a collection of all data, metrics, etc. relating to a common transponder or account identification code.

The exemplary method of FIG. 3 next involves determining whether a request for a driver's risk rating has been received, e.g., by the DRAS 200, as shown at step 310. For example, such a request may be received directly from an individual driver. In such an example, the request may be received by the DRAS in the form of the driver's transponder or account identification code, which may be provided by the driver via the driver's computing device 30a, 30b, for example by entering that information into a user interface of a web page supported by the DRAS. If so, in this example, the DRAS 200 responsively retrieves and transmits the driver's risk rating to the driver, as shown at steps 310 and 312. For example, this may involve searching the risk assessment data store for a driver risk rating associated with the transponder or account identification code provided by the driver, and then transmitting the driver risk rating to the driver's computing device 30a, 30b via a web server component 260 of the DRAS 200. Doing so will cause the driver's risk rating to be displayed to the driver via the driver's computing device 30a, 30b.

By way of alternative example, such a request may be received directly from an insurance company via the insurance company's computing system 20a, 20b, 20c. In such an example, such a request may again be received by the DRAS in the form of the driver's transponder or account identification code, which may have been provided previously by the driver to the insurance company. Such code may be received by the DRAS via a similar web site interface, or alternatively may be received via an alternative data exchange methodology that may be better suited for a larger volume of requests. Any suitable convention communications technology may be used for this purpose. After receiving the request, the DRAS 200 responsively retrieves and transmits the driver's risk rating to the driver, as shown at steps 310 and 312. For example, this may involve searching the risk assessment data store for a driver risk rating associated with the transponder or account identification code provided by the driver, and then transmitting the driver risk rating to the insurance company's computing system 20a, 20b, 20c, which in turn may cause the insurance company's system 20a, 20b, 20c to store the driver's driver risk rating for consideration as part of an automobile insurance underwriting/pricing process.

After transmitting the risk rating, or in the event that no request was received in step 310, then this exemplary method next determines whether the driver's risk rating should be updated, as shown at step 314. Any suitable methodology may be used for making this determination. For example, it may be determined that a driver's risk rating should be updated if a certain amount of time has passed since the last determination of a risk rating for the driver, or if a certain date is reached, etc. Alternatively, it may be determined that a driver's risk rating should be updated only in response to newly-received toll trip data for the driver.

Other examples include updating a drivers rating as a verification process at the time of a policy offering to a driver by an insurance company. For example, State Farm may offer a highly rated driver a discounted policy. Just prior to completing the policy sale, it would be beneficial for State Farm to verify the status of the rating. By way of further example, an insurance company would also want to periodically verify that the customer is maintaining the rating level they were insured at.

If it is determined in step 314 that the driver's risk rating should be updated, then the exemplary process repeats, as shown at step 302. If is determined that the driver's risk rating should not yet be updated, then the process flow may revert to determining whether a request for the driver's risk rating has been received, as shown at steps 314 and 310.

No matter the methodology used in step 314, it is preferable that the method provides for continually updating and evolving the driver's risk rating over an extended period of time, e.g., one or more years. By so providing, the driver's risk rating is updated in a dynamic and perpetual model. The system is perpetual since past and future trips are processed to calculate a continuously updated performance rating that is used to assess driver risk. Further, the ever-growing data upon which the driver risk rating is based ensures that anomalies provide less influence on the risk rating as a whole, and that the risk rating becomes increasingly accurate in representing the driver's risk over time.

By way of example, the method illustrated in FIG. 3 can be used to determine, with respect to a particular driver, whether the driver exceeded the speed limit, how often the driver exceeded the speed limit, whether the driver drives often or very infrequently, whether the driver tends to drive in lower-risk or higher-risk time frames, all of which can be reflected in a composite driver risk rating reflecting an overall risk profile based on demonstrated driver performance on toll highways. Notably, these indications of risk are determined as a function of the driver's historical toll trip data and certain static information that is constant for all drivers and generally constant over time—e.g., weekend dates, daytime hours, nighttime hours, distance between highway entry and exit points, etc.

Accordingly, these analyses are capable of identifying a consistency among the driver's driving data, by comparing and contrasting multiple trips and establishing various baselines. Over time, the system can thus identify drivers that tend to stay within baseline performance parameters with regard to individual driving behaviors. For example; you can determine if a daily commuter adheres to a 65 MPH speed limit regularly.

Further, this system provides a means to make a risk prediction based on a historically significant amount, e.g., months- or years-worth, of data from past trips. Further, the system can do so retroactively. Accordingly, you do not need to enroll in the system and the track data. Rather, you can enroll in the system today and assess past years' worth of data already captured and stored by the TTS. For example, if system can back process 5 years of stored data upon request and the driver rates well consistently, then they would likely be a lower-risk driver, and the driving metrics thus obtained would have a good predictive risk value.

FIG. 4 is a flow diagram 400 illustrating another exemplary method for developing a driver risk rating. In the example of FIG. 4, a particular driver's risk rating is develop as a function of that particular driver's toll trip history relative to the toll trip history of other drivers. Accordingly, in accordance with the present invention, this exemplary method accounts for the driving performance of other drivers in developing a driver risk rating for a single driver.

Referring now to FIG. 4, the exemplary method begins with receipt from a TTS 100 of toll trip data relating to each of a plurality of drivers, as shown at step 402. This data is received by the DRAS 200 and may be achieved in a manner similar to that described above with respect to step 302. By way of example, this step may involve receiving toll trip data as it is generated and stored, or alternatively, may involve receipt of data in a “batch mode,” e.g., by receiving an entire multi-driver historical toll trip data store for a given period.

In this exemplary embodiment, the DRAS 200 next processes each driver's toll trip data to determine toll trip metrics for the driver as a function of each driver's toll trip data, as shown at step 404. This may be performed by the risk assessment engine 280 of the DRAS 200 using the data processing logic 284, in a manner similar to that described with reference to step 304. Accordingly, this may involve use of not only each driver's historical toll trip data but also static data stored by or otherwise accessible to the DRAS 200. In addition to the metrics discussed above, the following metrics may be calculated or be otherwise determined. Generally, these metrics are related to context, or the ‘way’ a driver performs in relation to other drivers. These metrics provide context and consistency by comparing an individual trip to the trips of a relevant traffic volume and/or conditions encountered by drivers.

Direction of Travel—To calculate the contextual metrics described, the system determines a vehicle's direction of travel to identify the relevant traffic volume and/or conditions by which to make pertinent comparisons to since traffic on different sides of highways may experience different risk conditions. For example, traffic on the west bound side of the New Jersey Turnpike may be traveling at 65 MPH and the east bound side may be stopped for an accident.

Compared Volume—a measure of a number of drivers/vehicles making the same driver trip, e.g. between the same interchanges and/or at the same times, etc. For example, the number of vehicles using a stretch of toll highway from Interchange A to Interchange D can be calculated during a specific time frame, then an individual driver's trip can be compared against it. Compared Volume also becomes a volume-weighted metric; 200 cars during the same time frame may be weighted less than 2000 cars during the same time frame.

Volume Mean Speed—a mean speed calculated by determining the ‘Compared Volume’ of traffic on relevant sections of highway, across multiple interchanges or points and the speed of that specific volume. The timeframe and volume is extracted across the applicable points and the average speed of that specific volume is calculated. This metric is then used to compare and contrast individual driver trips.

Delta Volume Mean Speed—a calculation of the difference between a particular driver's Computed Trip Speed and the Volume Mean Speed. This volume may exceed the posted limit at times and therefore is a separate measure than the posted speed limit. This metric can identify the individual driver who travels faster than the overall traffic around him. This is a critical metric since these drivers often engage in other behaviors individual as tail gating, weaving through traffic and aggressive high risk driving behaviors.

Delta Mean Speed Total—the number of times a trip exceeds the Volume Mean Speed mean by N (e.g., 5) MPH or more. This could be tabulated by for a week/month/year or other rating period, and the excess speed threshold N may be tracked as a variable within the system.

Rush Hour Mean Speed—similar to ‘Volume Mean Speed’ except it is triggered by traffic volume and/or a time variable during morning and afternoon rush hour traffic times, which may be static information stored in the system. This metric specifically captures the speed of traffic volumes at the most congested times.

Delta Rush Hour Mean Speed. The difference between the individual Computed Trip Speed and ‘Rush Hour Mean Speed’ during morning and rush hour traffic or other congested traffic events. For example, a calculated value in excess of N MPH (e.g., a system variable) may be considered higher-risk behavior.

Delta Rush Hour Mean Total—an indication of the number of times the driver exceeded ‘Rush Hour Mean Speed’. This can be broken out by week, month, year and may be used in subsequent calculations. This metric can be represented as counter or a percentage for the rating period or by specific time period, such as week, month or year.

Mean Rush Hour Adherence %—the percentage of trips in which a driver exceeded the mean speed of the traffic volume around him during congested rush hour times. The system may provide a system variable for a cutoff threshold to be set by an insurance company, consistent with their risk assessment methodology. For example, if State Farm only wants the top 40% of drivers from the dataset available to them as customers then the cutoff may be set at 60%.

Mean Speed Adherence %—an indication of the percentage of trips in which a driver exceeded the Volume Mean Speed. This may be used to identify aggressive drivers and excessive speeders. The system may provide a system variable for a cutoff threshold to be set by an insurance company, consistent with their risk assessment methodology.

High Volume/Congestion Trips—a tabulation of how many times the driver commutes in high volume or congested traffic. A higher volume of cars may be accepted has being indicative of a higher risk of an accident. Volume is determined by ‘Compared Volume’. When compared volume reaches a predetermined volume threshold, the metric can be activated and a counter may be indexed upwardly. Traffic can congest based on rush hours, holiday traffic, special events or other influences such as traffic diversions from other large highway systems. This metric could be a tracked with a simple counter or as a percentage of all trips by rating period.

Green Trips—a metric derived from comparing congestion factors in relation to the drivers ‘hours of use’ to identify drivers that avoid congested traffic and rush hour times. Vehicles that avoid traffic congestion and rush hour travel are likely to save fuel, a ‘green behavior’. This metric represents a driver behavior that can be rewarded not only by an insurer but also by a toll highway system as a possible toll rate discount since the driver behavior lessons congestion and saves fuel.

Next, the DRAS 200 processes each driver's toll trip metrics in accordance with pre-defined data processing logic to develop a driver risk rating for each driver as a function of the driver's toll trip metrics relative to the other drivers' toll trip metrics, as shown at step 406. As described above with reference to step 306, such processing may be performed by the risk assessment engine 280 of the DRAS 200. It will be appreciated that virtually any satisfactory methodology or equation may be used to determine a driver risk rating as a function of the driver's toll trip history, static data, and other drivers' toll trip histories, and all such methodologies and equations are considered within the scope of the present invention.

By way of non-limiting example, consider that on a particular day an individual driver completed a trip between two points with an average speed of 77 mph. This trip is compared to stored traffic sensor data, or to computed volume speeds for a related time frame and location and determines the speed of the pertinent traffic volume between those two points was 68 mph, which reveals a +9 mph difference indicating the individual trip was outpacing the traffic volume. Taken alone, an individual trip may have limited predictive value. However, if this driver's other trips revealed that the driver consistently outpaced traffic for most trips, and/or did so in congested traffic as well as in weather conditions where the pertinent population traveled much slower, that provides greater predictive value. The predictive value may be further enhanced if the same driver made several trips on weekends during danger hours at higher speeds.

In this example, the captured metrics can be scored into general categories related to speed, mileage, time/day, congestion and weather. A simple non-limited exemplary method involves calculating and debiting a penalty/deduction value from each rated category starting with a perfect score of 1000. In this case, the total deduction is calculated based on;

1) a reduction value based on the number of times the driver exceeded the posted speed limit (−46),

2) a reduction value calculated for the delta value from the posted speed limit (−117) and,

3) a reduction value calculated from a more complex metric ‘delta mean speed total’ (−187) to arrive at a total deduction of 350 for that category.

Therefore, If the driver ‘lost’ 350 using the various speed metrics related to the speed risk category during the rating process, the resultant score in that category would be 650 (1000 perfect score−350 metric-related reduction). Each risk category can be similarly scored leaving a value in each category that can be totaled and divided by the number of categories applied to produce a final rating that is easily interpreted—in essence an average of all rated categories.

To illustrate the described procedure, assume the described driver scored 650, 882, 803, 785 and 816 in the respective five rating categories after the metrics were processed and deductions were made. The sum of these category scores is 3,936 which when divided by the number of categories, 5, produces a final risk rating of 787.2. Each driver's final risk rating can then be compared to the final risk ratings of all other drivers and numerically ranked at the appropriate position in the overall data set based on performance. Of course in a more complex example, the number of risk rating categories can be expanded to include contextual categories related to speed, congestion, weather, time/day and mileage, in essence doubling the rating categories used to calculate a final rating. Additionally, a category could be added to consider a drivers historical trip data. Any suitable methodology, including any suitable combination of metrics, respective weightings, rating scales, etc., may be used in accordance with the present invention.

Each driver's driver risk rating can then be stored by the DRAS 200, as shown at step 408, in a manner similar to that described above with reference to step 308. The system may then proceed to receive and respond to requests for drivers' risk ratings, and to update drivers' risk ratings, as shown at steps 410-414, in a manner similar to that discussed above with reference to steps 310-314.

It should be noted that the exemplary method of FIG. 4 provides additional opportunities and advantages for assessing driver performance, developing risk pools. For example, when the historical toll trip data is known to the DRAS for a plurality of drivers, each driver may be provided with a driver rating ranking that reflects each driver's risk rating/risk relative to other drivers. For example, based on all drivers' trips and respective risk ratings, drivers may be ranked from the best-rated driver to the worst-rated driver account. Various drivers' accounts may then be ranked and made available for discount consideration by insurers based on the insurance company's risk profile. For example, an insurance company can decide their level of policy risk and make offers to the top 20%, or perhaps the top 40% of ranked driver accounts. Perhaps they want to target the top 10% for a higher discount rate of 30%, etc. By way of example, the ranked population could be segmented for different discount levels; top 10% qualify for 30% discount, the next 10% qualify for a 20% discount, and so on.

Accordingly, the DRAS uses individual driver behavior, standing on its own and/or in relation to behavior of other drivers, to assess each driver's risk level for insurance purposes. Accordingly, the system can process all trip transactions in a toll database, make comparisons of the individual driver to various the traffic populations and highway conditions and then renders a performance rating for each account in the form of a driver risk rating. That driver risk rating can then be matched (e.g., by a participating insurance company) into a level of risk or an appropriate class of insureds based on their risk profile or by using variable weightings, etc., for the purpose of pricing an automobile insurance policy. Notably, this exemplary method makes contextual comparisons of how each driver performs in a dynamic and continuous way—against other drivers (e.g., the calculated moving traffic volume) and in view of highway/environment conditions.

Such contextual comparisons are useful, and avoid misinterpretation of data. For example, if it's snowing during a trip, the system compares the individual driver's speed on the snow-covered highway to the overall population traveling in the same conditions/timeframes. If a driver is outpacing others on the same highway or traveling faster than the moving population, the system will recognize this driver as a higher risk driver. In contrast, the telematics-based ‘Snapshot’ device uses only a few basic metrics and lacks the capability to make such a contextual comparisons to moving populations.

FIG. 5 is a flow diagram 500 illustrating an exemplary method for developing a driver risk rating as a function of the driver's toll trip history and external environmental factors. In the example of FIG. 3, a particular driver's risk rating is developed as a function of that particular driver's toll trip history relative to the toll trip history of other drivers. In the example of FIG. 4, a particular driver's risk rating is developed as a function of that particular driver's toll trip history relative to the toll trip history of other drivers. In the example of FIG. 5, a particular driver's risk rating is develop as a function of that particular driver's toll trip history and external environmental factors that generally involve gathering of data from independent data sources external to the DRAS and TTS. Accordingly, in accordance with the present invention, this exemplary method accounts for dynamic environmental factors that change dramatically over time in developing a driver risk rating for a single driver.

Referring now to FIG. 5, the exemplary method begins with receipt from a TTS 100 of toll trip data relating to each of a driver, as shown at step 502. This data is received by the DRAS 200 and may be achieved in a manner similar to that described above with respect to step 302.

In this exemplary embodiment, the DRAS 200 next receives from an external data store information identifying environmental factors, as shown at step 504. By way of example, such environmental data may be received by the DRAS 200 from external data sources 270 that communicate with the DRAS 200 via a communications network 40. By way of example, these data sources 270 may be pre-existing web servers that operate independently for their own distinct purposes, yet provide data that can be repurposed and used in accordance with the teachings herein. By way of example, the external data may represent weather data, traffic congestion/accident data, declaration-of-emergency data (e.g., in the event of a snow emergency of the like, in accordance with existing government processes), etc. Such data may be retrieved from applicable databases, received as a data stream or feed, may be delivered via web services, or may be otherwise distributed and received and consumed in any conventional manner. Technologies for such dissemination and consumption of data are outside the scope of the present invention and thus are not discussed in detail herein.

In one embodiment, the external data source is an Intelligent Transportation System (ITS) data feed. Such ITS data feeds already exist and are commercially available (e.g., via INRIX) for use, e.g., for traffic data information. In such an embodiment the DRAS 200 integrates existing data feeds utilized by some toll highway systems and leverages these data feeds to provide additional contextual information in assessing driver performance. It should be noted that data feeds and/or sources may be internal or external to the toll transportation system.

It should be noted that alternatively a system of traffic-sensing sensors may be deployed independently of any toll transportation system to gather and provide driver behavior data consistent with the present invention. Accordingly, the references to a toll transportation system are exemplary, and not limiting.

Next, the DRAS 200 identifies environment parameters associated with the drivers' trips as a function of the driver's toll trip data, as shown at step 506. This may be performed by the risk assessment engine 280 of the DRAS 200 using the data processing logic 284. By way of example, this may involve determining a geographic area of travel and time/date for a particular trip, and then determining from the environmental data applicable weather conditions for that same geographic area of travel in the same time/date timeframe.

The DRAS 200 then processes the driver's toll trip data and the applicable environmental parameter data to determine toll trip metrics and a driver risk rating for the driver, as shown at step 508. This may be performed by the risk assessment engine 280 of the DRAS 200 using the data processing logic 284, in a manner somewhat similar to that described with reference to step 304. Accordingly, this may involve use of not only each driver's historical toll trip data and static data stored by or otherwise accessible to the DRAS 200, but also environmental data received from the external data sources 270. In addition to the metrics discussed above, the following metrics may be calculated or be otherwise determined. Generally, these metrics are related to environmental factors that change over time, and thus provide context for the raw data. For example, driving at an average rate of speed of 55 MPH on a toll highway might be safe in dry weather conditions, but might be an indication of higher risk if the drive occurs during a snowstorm.

Weather Condition Visibility—a metric that compares the Computed Trip Speed to Volume Mean Speed during times of limited visibility, such as dense fog, dust storms, or smog, as indicated by external (e.g., ITS) data.

Weather Condition Snow—a metric that compares the Computed Trip Speed to Volume Mean Speed during times of snow, as indicated by external (e.g., ITS) data.

Weather Condition Rain—a metric that compares the Computed Trip Speed to Volume Mean Speed during times of rain, as indicated by external (e.g., ITS) data.

Weather Conditions Mean Speed—a metric relating the Volume Mean Speed during times of limited visibility including rain, snow, sleet, fog and other weather conditions as indicated by external (e.g., ITS) data.

Weather Conditions Delta Total—a metric relating the number of times the driver's Computed Trip Speed exceeded ‘Weather Conditions Mean Speed’ under poor weather conditions such as snow or rain.

Declared Emergency speed—a parameter identifying a temporary speed limit established for certain times when weather emergencies have been declared by local government, such as during- or post-blizzard conditions or in other emergencies, as indicated by external data.

Congestion Hours %—a metric identifying the percentage of time spent by the driver in higher-risked congested traffic. This can be determined by volume, time and speed counters that parallel the individual trip. It can be broken up into individual volume, time and speed congestion factors down the road if that's determined to be practical. It should be noted that this metric may be calculated from gathered data, or alternatively may be provided from an external data source (e.g, via an ITS).

Highway risk calculation—congestion. Variable risk can assigned to sections of highway, such as between toll points, based on congestion, usage means, traffic sensors, and crash data, etc. The system can calculate if certain sections of highway are mis-used dynamically when compared to other sections of the highway. In essence, the system rates and applies road risk which differs from place to place. This could be on a daily, weekly, monthly basis, or even applied on a per-trip basis.

Highway risk calculation—weather. Certain weather conditions, congestion, speed and curves in snow, rain, fog and under visibility conditions, changes that section of highway risk. This can accomplished by incorporating intelligent weather mapping systems over the toll highways and comparing driver trips.

Crash data integration. Crash data layers can be overlaid on tolled highway sections. More crashes in certain sections means higher risk. Relevant crash data may be provided via an external data source. For example, in Pennsylvania, police reports capturing crash data are stored in a database, and such crash data includes time, day, date and location that may be incorporated into a risk model.

Cellular Usage Metrics. Cellular usage metrics can be integrated with particular attention to usage during danger hours or in congested traffic, or usage in poor weather conditions. For example, the call volume and/or usage of cell towers positioned along a toll highway can be integrated into the model as a feed and be used to calculate a likely volume of drivers using cellular devices along those stretches. This may then be used to calculate a risk factor. For example, there would be a certain level of risk associated with a particular section of highway if it was determined that 20% of the drivers were utilizing cellular devices. The higher the usage, risk increases.

Weather Conditions Adherence % The percentage of trips a driver exceeded the mean speed of the traffic volume during poor weather conditions, such as rain or snow. This metric can be calculated by integrating a weather related data feed from an outside source, such as from the national weather service. The data may be used in various weather related metrics to measure driver behaviors in the weather related conditions experienced by the driver.

Other Aspects of the Driver Risk Rating

As described above, the various metrics and/or parameters referenced above may be used in determining a risk rating for a driver that reflects an automotive insurance risk profile. As referenced above, such a rating may be determined by use of an equation that may provide different weights to one or more metrics in determining a composite value that is the driver risk rating. The weightings may be applied by multiplying the metric by a weighting coefficient. In accordance with the present invention, the DRAS may receive and/or store information, such as an equation or a list of weighting coefficients, that each insurance company wishes to be used in determining a risk rating for its use in underwriting/pricing an automotive insurance policy for a driver. By way of example, an insurance company may adjust the weights geo-locally, i.e., such that each company establishes their own preferred weightings by state, by milepost, by congestion, by data sensor reads, etc. geographic region, etc. For example, an insurance company may provide that very low weighting (e.g., via a low coefficient) should be used in determining driver risk ratings in accordance with its preference to de-emphasize or eliminate snow-related risk for drivers that reside in a warmer climate where snow is a rare occurrence, such as in Florida. Accordingly, drivers may receive different ratings on different scales according to the differing methodologies/weightings used for each insurance company. For example, a driver might have a risk rating of 500 in accordance with Allstate's policies, 700 for GEICO, and 800 for Progressive. This tends to provide the insurance company with greater control over its underwriting choices, and to provide the driver with a broader range of discount options. Accordingly, the system is designed to work independent of insurance companies to make the risk determination, but a mechanism is provided to allow the insurance companies with some limited control over how to influence the weighting of the various metrics so that the driver risk rating output meet their underwriting needs and preferences. Each company can create and coordinate multiple ‘risk profiles’ that would allow them to assign a proper discount and policy price, on a geo-local basis. For example, the weight assigned to certain behaviors, such as excessive speeding in snow, can be adjusted by insurance partners. This may be helpful since less risk is associated with snow in Florida than in Illinois, where snow-related crashes have a much higher risk value.

In another embodiment, driver risk rating calculation is universal and can be easily interpreted and/or adjusted by the insurance industry for their individual needs.

Further, the DRAS creates a new and specific class of services for lower risk drivers. Specifically, the DRAS may provide a specific web-based platform configured to direct-connect lower-risked drivers (with lower driver risk ratings) to an insurance company, car rental or other partners. Accordingly, the DRAS can be operated independent of any particular insurance company to identify, qualify and channel safe drivers to a platform to direct connect them in a simple way to insurance partners for competitive discounts and incentives. Further, the system provides a consumer-friendly driver risk rating that is much like a financial ‘credit rating,’ and introduces the ability to create a performance-based perpetual risk rating for individual drivers. Accordingly, the system provides a transparent rating that can be easily understood by a multitude of customers and that can be used when comparison shopping for insurance. Since several years of stored toll data can be retroactively processed (since the data already exists and is accessible), when combined with a driver's future toll trips, a long term and perpetual performance record is created that can be rated and used in the auto industry to predict long term risk.

Further, analytics may be performed on the data gathered by the DRAS to provide feedback for determining new risk factors that may then be used to determine a risk rating. These risk factors may be presently unidentified or unidentifiable by the insurance industry. For example, since the system can determine which sections of highway have the most volume and most drivers, and can put those drivers into context based on how they use the highway, the system can determine which sections of road have the most risk. For example, a congested section of highway has a higher risk, but there could be sections of highways with curves that have elevated risk during periods of bad weather and increase the chances of crashes, such as in snow conditions. By correlating observed accident data with highway segments, traveling a particular highway segment may be identified as a risk factor, which may be tracked, and may be accounted for in assessing driver performance and developing driver risk ratings. Accordingly, the DRAS will provide an extensive data store with extensive data itself that may be used in the insurance industry for underwriting purposes. The DRAS provides a new dynamic, contextual and robust system capable of differentiating and coordinating risk among millions of drivers, and thus ultimately permits the auto industry to more accurately price the cost of an automobile insurance policy, which is generally consistent with current PAYD (“pay as you drive”) or PHYD (“pay how you drive) underwriting and pricing policies, which are a departure from conventional actuarial methods.

Driver Information Portal

Referring now to FIG. 6, an exemplary graphical user interface window 600 is shown displaying an exemplary web page. The web page is supported by the DRAS 200, and particularly its web server 260, and is configured to transmit driver risk rating data to drivers 30a, 30b via their client computing devices. FIGS. 7-10 shown additional exemplary graphical user interface windows in the form of web pages supported by the DRAS and browsable by a consumer using his/her client computing device.

As discussed above, the data processed by the DRAS is preferably anonymized, such that individual privacy is protected. Specifically, ratings and driving data are preferably associated only with transponders/accounts, and individual driver identities remain anonymous throughout the process, until they perform and affirmative action to identify themselves to the DRAS or an insurance company by providing their transponder or account identification code. Accordingly, the inventive system contrasts with prior art systems that require the driver to first identify himself/herself to the insurer, prior to any determination of a safe driver discount. The DRAS described herein permits the driver to remain anonymous until after a driver risk rating has been developed, and until the driver chooses to reveal his/her identify to an insurer, if desired.

Accordingly, the unique toll transponder/account number the driver uses on a toll system is the primary access key for the driver data and risk rating. In such an embodiment, the driver is permitted to participate in a non-intrusive way until the driver wants to approach an insurance company for a discount. In such a case, drivers may log into the DRAS-supported website anonymously using their transponder (or account) number to check their performance and discount availability, e.g. by providing such information to the DRAS via a web page interface such as the exemplary window shown in FIG. 6. Once logged into the system, the system may display trip summary information, driver performance information, and a composite driver risk score reflecting an overall risk rating on a standardized scale corresponding to the provided transponder number, as will be appreciated from FIGS. 7 and 8. As referred to above, the system may also permit the user to select the metrics to be used in calculating metrics and/or ratings for insurance purposes by presenting the user with a user-selectable menu of risk factor and permitting the user to selective include or exclude them and initiate recalculation of the risk rating, as will be appreciated from FIG. 9.

These transponder numbers may also be used as the key for passing discount data between the instant “Tollemetry” system and an auto insurance partner, and to integrate with the toll highway system. For instance, a customer may contact State Farm to get a policy and provide their transponder number to acquire a discount as a result of the driver safety rating associated with their transponder number. The system may present the user with a menu of insurance companies and available discounts as a function of the driver's risk rating, rank, etc., so that the driver can initiate contact with an insurance company and obtain discounted insurance, as will be appreciated from FIGS. 9 and 10.

The system may include functionality for checking to see if a provided transponder number has previously been used, and may limit or prohibit repeated use of a single transponder number. Transponders used more than once may trigger an exception and be quarantined. The system may further provide for validation of the provided transponder number against a trusted data source. State Farm (e.g., its system 20a, 20b, 20c) may then communicate with the DRAS 200 to retrieve and verify the customer's performance rating electronically using the transponder/account number, and the DRAS would not need to know the customer's personal information.

Further, prior art systems and driver risk determinations have been made by individual insurance companies who direct customers to their web properties to purchase insurance products. In contrast, in the context of the present invention, such systems, insurance, toll and other companies can connect to a low-risk driver population via the system's web interface. The DRAS differentiates the driver population from the dataset, then brings insurer-partners to the DRAS platform; this preserves driver privacy, makes insurance rates competitive for lower risk drivers and prevents the insurance industry from collecting personal driving data on individual drivers who may not become customers or be otherwise prejudiced.

DRAS Efficacy

Further, the DRAS can be used as a hub and repository of information that may have further value to the insurance industry. Accordingly, the DRAS 200 may further track and store the following metrics:

Tollemetry Mileage Risk %. The difference of mileage traveled on toll systems versus a drivers annual mileage converted to a percentage. By tabulating the mileage of all trips a driver accrues while traveling on a TTS during a period of time, such as annually, a calculation can be made to determine the percentage of miles a driver spends on the TTS against the overall miles driven annually. This metric reflects a percentage of miles that a drivers behavior can be computed and a rating completed versus travel on roadway and environments that cannot be captured and computed. For example, if a driver accrued 7,500 miles on a TTS that resulted in a rating for the driver and the driver accrued 10,000 miles for the year, then there are 2,500 miles that were not rated. An insurance partner may make an assumption as to the drivers likely driving behavior for the 25% of unrated mileage.

Tollemetry Total Mileage %. The reported annual mileage versus the total Tollemetry mileage reflected as a percentage, as described above.

Tollemetry Payout %. The percentage of claims on the Tollemetry population of drivers. Crash related only, not criminal or otherwise initiated.

Tollemetry Safe Driver %. The % of Tollemetry drivers insured by a company that are without claim. Should be proportionate to above.

Tollemetry discount. The discount % assigned to the Tollemetry customer by the insurance company.

Tollemetry Savings. The insurance company reported amount of money saved for being a Tollemetry customer.

Tollemetry Retention %. The volume of Tollemetry drivers that are retained by partners at policy renewal.

Coordinated Telematics %. A driver can use a telematics device and have a Tollemetry rating. The two different methods and values can be coordinated to provide an even higher degree of risk qualification and a higher discount.

Tollemetry/Telematics DB integration. Tollemetry data can be integrated into existing actuarial and telematic databases/datasets of individual insurance companies for research, new metrics, integration into their own processes or to develop new methods to evaluate risk and policy pricing. A combined system has even more potential to add millions of drivers that can be analyzed over hundreds of millions miles per year.

FIG. 10 is a schematic diagram showing an exemplary driver risk assessment system (DRAS) 200 in accordance with an exemplary embodiment of the present invention. The DRAS 200 is shown logically in FIGS. 1 and 2 as a single representative server for ease of illustration only. The DRAS 200 includes conventional server hardware storing and executing specially-configured computer software for carrying out a method in accordance with the present invention. Accordingly, the exemplary DRAS 200 of FIG. 10 includes a general purpose microprocessor (CPU) 202 and a bus 204 employed to connect and enable communication between the microprocessor 202 and the components of the DRAS 200 in accordance with known techniques. The exemplary DRAS 200 includes a user interface adapter 206, which connects the microprocessor 202 via the bus 204 to one or more interface devices, such as a keyboard 208, mouse 210, and/or other interface devices 212, which can be any user interface device, such as a touch sensitive screen, digitized entry pad, etc. The bus 204 also connects a display device 214, such as an LCD screen or monitor, to the microprocessor 202 via a display adapter 216. The bus 204 also connects the microprocessor 202 to memory 218, which can include a hard drive, diskette drive, tape drive, etc.

The DRAS 200 may communicate with other computers or networks of computers, for example via a communications channel, network card or modem 222. The DRAS 200 may be associated with such other computers in a local area network (LAN) or a wide area network (WAN), and may operate as a server in a client/server arrangement with another computer, etc. Such configurations, as well as the appropriate communications hardware and software, are known in the art.

The DRAS's software is specially configured in accordance with the present invention. Accordingly, as shown in FIG. 10, the DRAS 200 includes computer-readable, microprocessor-executable instructions stored in the memory for carrying out the methods described herein. Further, the memory stores certain data, e.g. in databases or other data stores shown logically in FIG. 10 for illustrative purposes, without regard to any particular embodiment in one or more hardware or software components. For example, FIG. 10 shows schematically storage in the memory 218 of web server software 260, a risk assessment engine 280 including data processing logic 284 for determining toll trip metrics, determining driver risk ratings, and ranking drivers by driver risk ratings, and a risk assessment data store 22 including driver account data 230 including driver toll transaction data 250 and driver rating data 240. Optionally, other data may be stored in the memory as discussed herein, such as driver rankings and environmental data retrieved from external data stores. The memory may further store data for displaying and/or communicating driver risk information, promotional offers and the like to drivers and/or insurance companies, as discussed herein.

Additionally, computer readable media storing computer readable code for carrying out the method steps identified above is provided. The computer readable media stores code for carrying out subprocesses for carrying out the methods described above.

A computer program product recorded on a computer readable medium for carrying out the method steps identified above is provided. The computer program product comprises computer readable means for carrying out the methods described above.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for providing a driver risk rating representative of driver performance using a computer-implemented system comprising a microprocessor and a memory, and instructions stored in the memory for implementing the method, the method comprising:
receiving from a toll transaction system toll trip data, the toll trip data reflecting data recorded as a result of operation of an automobile associated with at least one driver;
processing the toll trip data to determine toll trip metrics as a function of the toll trip data; and
processing the toll trip metrics in accordance with predefined data processing logic to develop a driver risk rating for each driver as a function of the toll trip data.

2. The method of claim 1, wherein receiving from a toll transaction system comprises receiving toll trip data from a toll transaction system operated under governmental authority.

3. The method of claim 1, wherein receiving the toll trip data comprises receiving data captured via an RFID transponder.

4. The method of claim 3, wherein the RFID transponder is associated with a unique identification number, and wherein said driver risk rating is stored in association with the unique identification number apart from any personally identifiable information of the driver.

5. The method of claim 1, wherein receiving the toll trip data comprises receiving aggregated data for a plurality of drivers.

6. The method of claim 1, wherein processing the toll trip data comprises processing toll trip data for a plurality of drivers.

7. The method of claim 1, wherein said toll trip data comprises data recorded by a tolling agency as a routine operation associated with operation of a toll highway, and wherein processing the toll trip data comprises processing an existing datastore of toll trip data.

8. The method of claim 1, wherein receiving the toll trip data from the toll transaction system comprises receiving the toll trip data during a trip reconciliation process of the toll transaction system, prior to association of the toll trip data with any personally identifiable information of the driver.

9. The method of claim 1, wherein said toll trip data comprises data recorded over a plurality of years.

10. The method of claim 1, wherein processing the toll trip data to determine the toll trip metrics comprises making comparisons among a single driver's trip data.

11. The method of claim 1, wherein processing the toll trip data to determine the toll trip metrics comprises making comparisons between a single driver's trip data, and aggregated trip data for a plurality of drivers.

12. The method of claim 1, wherein processing the toll trip metrics to determine the driver risk rating comprises making comparisons between a single driver's toll trip metrics, and aggregated toll trip metrics for a plurality of drivers.

13. The method of claim 1, wherein processing the toll trip metrics to determine the driver risk rating comprises determining the driver risk rating as a function of contextual information.

14. The method of claim 1, wherein the contextual information relates to at least one of a location, a weather condition, a time of day, a day of week, and a time of year.

15. The method of claim 1, further comprising:
receiving via a communications network a request for the driver's risk rating; and
transmitting via the communications network, the driver's risk rating.

16. The method of claim 15, wherein the driver risk rating is a numerical score within a predefined numerical range.

17. The method of claim 15, wherein the receiving the request comprises receiving a transponder number associated with the driver.

18. The method of claim 15, further comprising:
retrieving from a data store insurance rate information as a function of the driver's risk rating; and
transmitting via the communications network information for displaying the insurance rate information.

19. The method of claim 1, wherein said receiving and processing are performed for each of a plurality of drivers to calculate a plurality of driver risk ratings, the method further comprising:
assigning to each driver a ranking reflecting each driver's risk rating relative to other drivers' risk ratings.

20. The method 1, further comprising:
receiving from an external data store information identifying environmental factors;
identifying environmental parameters associated with the driver's trips as a function of the driver's toll trip data; and
processing the toll trip data and environmental parameters in accordance with pre-defined data processing logic to develop the driver risk rating.

21. The method of claim 1, further comprising:
displaying to a driver a menu of user-selectable toll trip metrics; and
receiving from a driver input identifying at least one user-excluded toll trip metric;
wherein processing the toll trip metrics to determining the driver's risk rating comprises excluding consideration of the user-excluded toll trip metric.

22. A driver risk assessment system for providing a driver risk rating representative of driver performance, the system comprising:
a processor;
a memory operably connected to the processor for storing instructions; and
instructions stored in the memory for causing the system to:
receive from a toll transaction system toll trip data, the toll trip data reflecting data recorded as a result of operation of an automobile associated with at least one driver;
process the toll trip data to determine toll trip metrics as a function of the toll trip data; and
process the toll trip metrics in accordance with predefined data processing logic to develop a driver risk rating for each driver as a function of the toll trip data.

23. A tangible computer-readable medium storing a software application comprising a first instruction set for causing a computing device to perform the method of claim 1.
